(19) United States
(12) Patent Application Publication
(10) Pub. No.: US 2003/0164358 A1
(43) Pub. Date: Sep. 4, 2003

(54) Device and method for generating a print image in a laser-marking system

(76) Inventor: Patrick Ward, Park Ridge, IL (US)

Correspondence Address: WITHROW & TERRANOVA, P.L.L.C., P.O. BOX 1287, CARY, NC, 27512, US

(21) Appl. No.: 10/377,074

(22) Filed: Feb. 28, 2003

Related U.S. Application Data
(60) Provisional application No. 60/360,800, filed on Mar. 1, 2002.

(51) Int. Cl. B23K 26/00

(52) U.S. Cl. 219/121.7

(57) ABSTRACT

A laser-marking system that emits a laser beam through an acousto-optic deflector and onto a product to form dot-markings on the product. The acousto-optic deflector defects the laser beam depending on the frequency emitted to the acousto-optic deflector. A controller controls the laser to emit a laser beam when desired, and controls a digital frequency synthesizer to emit the desired frequency to the acousto-optic deflector. The user and/or controller may configure the laser-marking system to determine the efficiency of the acousto-optic deflector to determine correct amplitudes of dot frequencies to give the desired dot intensity on a product. Theses amplitudes are stored in memory as dot-marking profiles. The controller access the dot-marking profile to print dot markings onto products as desired. The user and/or the controller may also control scaling, vertical placement and overlapping of dot markings printed onto products.

### RELATED APPLICATION

This application claims the benefit of U.S. Provisional patent application Serial No. 60/360,800, filed on Mar. 1, 2002.

### FIELD OF THE INVENTION

The present invention relates to a laser-marking system using an acousto-optic deflector (AOD) that places informative markings onto products.

### BACKGROUND OF THE INVENTION

Marking systems are used to place informative markings on products, typically during their manufacture and/or distribution. Informative markings include useful information about the product; for example, an expiration date, “born-on” date or date of manufacture, lot number, place of manufacture, and the like.

Laser-marking systems use a laser to place informative markings on products. A laser emits a laser beam that is directed to the product to etch informative markings onto the product. The laser beam may etch the surface of the product or a coating placed on the product beforehand. At times, laser-marking technology has certain advantages over other marking technologies, e.g., ink jet printing technology. For example, the maintenance of laser equipment may be easier and more economical in certain circumstances than the maintenance of other types of markers. Since the laser-marking technology does not depend on the use of ink in a liquid state to produce a mark, it is less prone to printing problems caused by ink.

In addition, laser-marking technology allows marking of substrates at extremely high speeds. An example of the use of this technology is in the marking of expiration dates on plastic soda bottles. During laser-marking, the rate of movement of the conveyor carrying the soda bottles generally ranges from about 100 to 300 feet per minute, and it can be as high as 500 feet per minute.

In certain laser-marking systems using an acousto-optic deflector (AOD), a laser emits a laser beam through an AOD onto the product. A frequency signal is emitted into the AOD to deflect the laser beam. There is a known correlation between the frequency emitted to an AOD and the index of refraction of the AOD. The AOD deflects the laser beam into different regions on the product in a vertical array to create information markings in the form of dots. A controller controls the laser to emit a laser beam at the desired time. The controller also controls frequency emissions to the AOD to place dots on the desired areas of the product. The laser beam places dots in the vertical plane thereby creating two-dimensional informative markings on the product as the product moves in a horizontal direction with respect to the laser beam.

Some laser-marking systems only have a fixed number of oscillators to emit frequencies into an AOD, thereby only allowing a laser beam to be deflected in a fixed number of discrete locations on a product. A different oscillator must be provided to deflect the laser beam for each particular location desired. For instance, if eighteen different deflection areas are desired, eighteen different oscillators generating eighteen different frequencies must be provided. In addition, a switching means must be provided to select a particular oscillator to emit the desired frequency. Such laser-marking systems do not allow deflection of the laser beam in a modified fashion, such as generating the same number of dots over a smaller frequency range of the AOD, since the fixed oscillators cannot be programmed to generate intermediate frequencies.

More advanced laser-marking systems employ a programmable frequency synthesizer to generate multitudes of frequencies into the AOD in a given frequency range. A programmable frequency synthesizer allows a laser-marking system the flexibility to generate frequencies as programmed or controlled by a control system. In this manner, the laser-marking system can dynamically control a laser beam in the vertical direction without being limited to a fixed number of deflection locations.

However, such laser-marking systems do not fully take advantage of the power of a programmable frequency synthesizer to allow a user or technician to control the operation of such to provide a user and/or control system more flexibility and features in laser-marking, such as configuring and storing profiles for dot marking, providing a user interface, and allowing control of height, scaling, and vertical placement of images. In addition, a user or technician may have more control over the operation of the laser-marking system during manufacturing, configuration and/or operation if a user interface is provided that allows modification of operation.

### SUMMARY OF THE INVENTION

The present invention relates to a laser-marking system that includes a user interface and a programmable digital frequency synthesizer to place informative markings on products in the form of dot markings.

The digital frequency synthesizer is under the control of a controller in the laser-marking system. The digital frequency synthesizer acts as a frequency synthesizer to emit frequencies selected by the controller to an AOD. A laser beam is emitted by a laser into the AOD. The controller controls the frequency synthesizer to emit the desired frequency signal into the AOD to deflect the laser beam onto a product to form a dot marking at the desired location.

In one embodiment, the user interacts with a user interface associated with a controller to create at least one dot marking. More than one dot-marking profile may be created and stored in memory. The dot-marking profiles contain dot frequencies and amplitudes of the dot frequencies emitted into the AOD to equalize the laser beam power due to varying efficiencies in the AOD for different frequencies.

The controller may also be configured to automate the dot-marking profile creation process without the need for interaction and/or control by a user. The controller may either use an existing dot-making profile as a base to create a new dot-making profile using interpolation, or the controller may calculate and store the efficiency curve of the AOD to use for interpolating a new dot-making profile.

In another embodiment, the user and/or the controller may adjust the image height of dot markings on a product by controlling the frequency signals of a frequency synthesizer emitted into the AOD. Since the frequency synthesizer is programmable and is not limited to a particular discrete amount of frequencies, the laser-marking system can deflect the laser beam to form dots of varying heights and at varying dot intensities.

In another embodiment, the user and/or the controller may adjust the image height of dot markings so that dots overlap one another when emitted onto a product. This technique is used to increase the resolution of dot markings on a product.

In another embodiment, the user and/or the controller may adjust the base frequency signal emitted into the AOD to control vertical placement of the dot markings on the product. The controller may be configured to print dots on one or more lines of products, and may be configured to have preset vertical placement configurations, such as top, bottom, and middle.

In another embodiment, the user and/or the controller may adjust the scaling of dot markings above or below full scale. Adjustment down of scaling causes the laser-marking system to print and compress the same amount of dots in a smaller space. Adjustment up of scaling causes the laser-marking system to print the same amount of dots spread over a larger space.

In another embodiment, the laser-marking system provides a user interface to allow a user to configure and/or program the laser-marking system, such as creating a dot-marking profile stored in memory. The user interface may also be used to enter text or graphics to be printed on products, adjust amplitudes of particular dot frequencies in dot-marking profiles, configured power used by the laser, and/or be used to adjust image height, overlapping and vertical placement of dot markings placed of products.

### BRIEF DESCRIPTION OF THE DRAWINGS

FIG. 1 is a schematic diagram of a laser-marking system in the prior art;

FIG. 2 is a schematic diagram of a laser-marking system according to the present invention;

FIG. 3 is a schematic diagram of one embodiment of the controller;

FIG. 4 is a schematic diagram of an AOD efficiency curve;

FIG. 5A is a schematic diagram of a dot-marking profile having eighteen dot frequencies with frequency increments of 1.5 MHz and an initial dot frequency of 27 MHz;

FIG. 5B is a schematic diagram of a dot-marking profile having eighteen dot frequencies with frequency increments of 0.5 MHz between each dot frequency and an initial dot frequency of 41 MHz;

FIG. 6 is a flowchart illustrating the creation of a dot-marking profile in memory;

FIG. 7 is a flowchart illustrating dot marking on a product using a dot-marking profile contained in memory;

FIG. 8A is a schematic diagram illustrating a 16×16 dot marking font using the dot-marking profile illustrated in FIG. 5A with no scaling and vertical placement offset to the middle;

FIG. 8B is a schematic diagram illustrating a 16×16 dot marking font using the dot-marking profile illustrated in FIG. 5A with scaling at 44% and vertical placement offset to the bottom; and

FIG. 8C is a schematic diagram illustrating an example of a 5×7 dot marking font using the dot-marking profile illustrated in FIG. 5A with no scaling and vertical placement offset to the bottom.

### DETAILED DESCRIPTION OF THE INVENTION

The present invention relates to a system and method for generating a print image, or dot markings, to place informative markings on products, materials and/or other substrates. A laser-marking system is provided that employs an acousto-optical deflector (AOD) to deflect a laser beam emitted by a laser onto a product. Such informative markings may be placed on products during their manufacture and/or distribution. Informative markings may include any useful information concerning the product, including but not limited to expiration date, “born-on” date or date of manufacture, lot number, and any other product information desired.

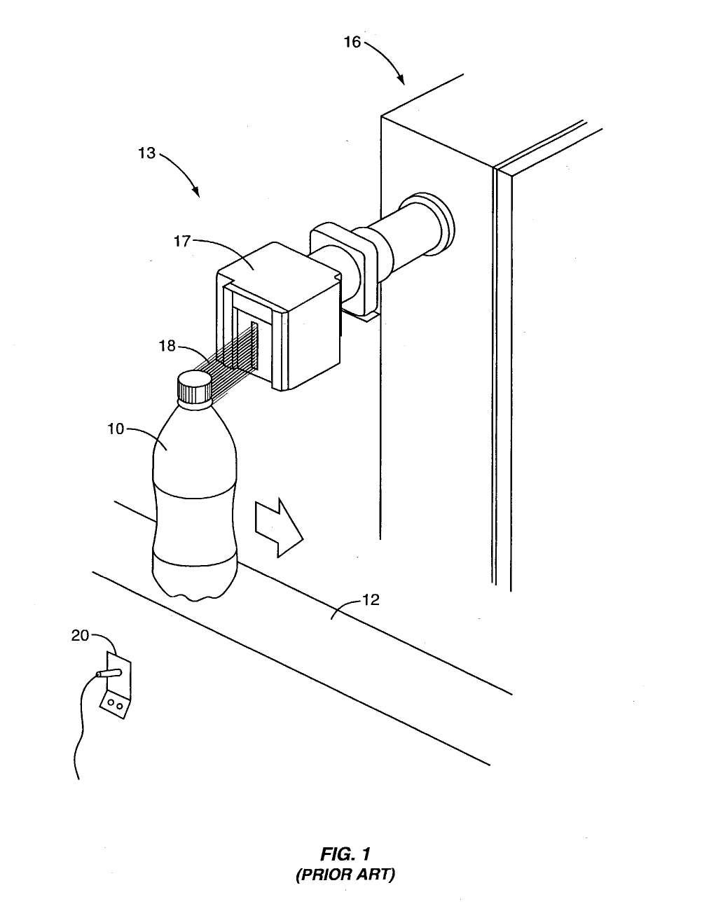

FIG. 1 illustrates a typical laser-marking system employing an AOD (not shown in FIG. 1) for placing information markings on products that is known in the prior art. Products 10 are transported on an assembly line 12 in front of a laser-marking station 13. The laser-marking station 13 contains a laser 16 that emits a laser beam 18 onto the product 10 to place information markings on the product 10. The laser 16 contains a laser head 17 where the laser beam 18 is emitted outside of the laser 16. A product detection sensor 20 detects the presence of the product 10 as it begins to pass in front of laser-marking station 13 to control the firing of the laser 16. The laser beam 18 passes through an AOD (inside the laser head 17) before it reaches the product 10.

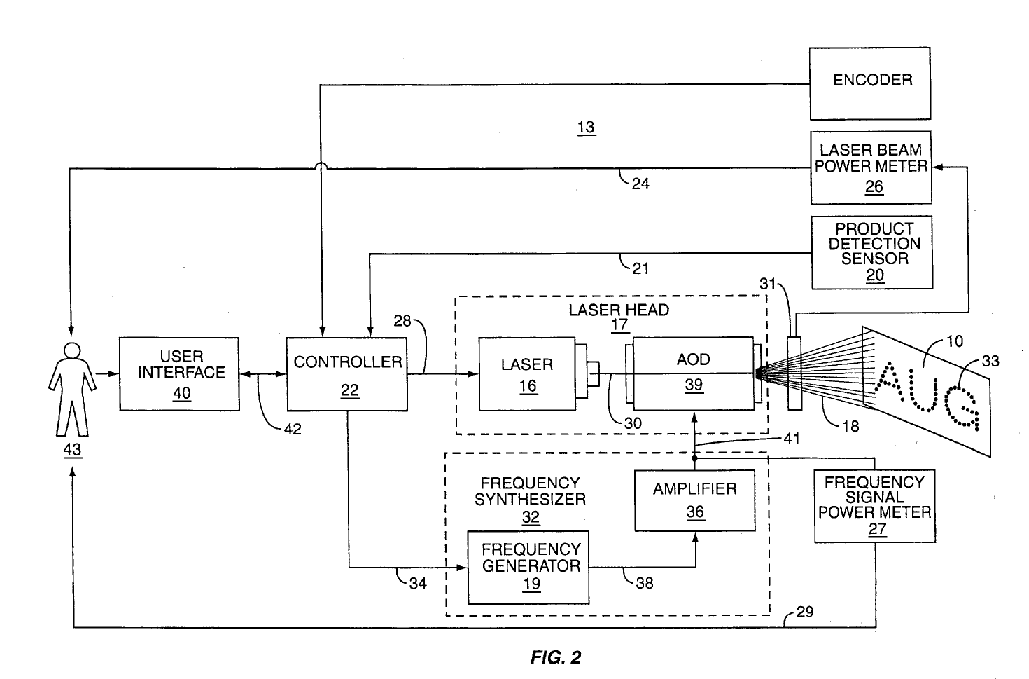

The laser-marking station 13 controls a frequency synthesizer (illustrated in FIG. 2) to emit a frequency into the AOD to deflect the laser beam 18 to the desired portion of the product 10. The laser-marking station 13 controls the laser 16 and the emission of the laser beam 18 so that marking dots are placed onto the product 10 in a vertical direction. As the product 10 moves horizontally with respect to the laser-marking station 13, the laser 16 places dot markings on the product 10 to form two-dimensional information markings. Additional examples of laser-marking systems like that described above and illustrated in FIG. 1 are described in U.S. Pat. No. 5,021,631 and European Patent Application EP 0 845 323 A1, incorporated herein by reference in their entirety.

FIG. 2 illustrates a block diagram of the laser-marking station 13 according to the present invention. A controller 22 is provided that outputs a laser control signal 28 to the laser 16 to control when the laser 16 emits an undeflected laser beam 30. In one embodiment, the laser 16 emits the laser beam 30 at a power of approximately 130-140 Watts. The controller 22 may be a microprocessor, micro-controller or other electronic circuitry. The controller 22 also controls a frequency synthesizer 34 comprised of a frequency generator 19 and an amplifier 36 to emit a dot frequency signal 38 into the AOD 39. The controller 22 causes the frequency synthesizer 34 to emit a dot frequency signal 38 that is amplified by the amplifier 36 to obtain the desired intensity of the laser beam 18 as it contacts the product 10 to form the dot markings 33.

In one embodiment, the amplifier 36 is capable of amplifying the dot frequency signal 38 between 0 and 50 Watts. Also in this embodiment, the AOD 39 is a germanium crystal. However, the AOD 39 may also be made out of other materials, such as quartz, glass, gallium phosphide, lithium niobate, lead molydbeate, or tellirium, and the present invention is not limited to any particular type of material for the AOD 39.

In one embodiment, the frequency synthesizer 34 may be a digital frequency synthesizer. A digital frequency synthesizer allows the controller 22 and/or user interface 40 full control over the frequency of the frequency signal 41 and its amplitude emitted into the AOD 39. An example of a digital frequency synthesizer is Analog Devices AD9852, whose data sheet information is entitled “CMOS 300 MHz Complete-DDS,” and is incorporated herein by reference in its entirety. AD9852 provides an integrated circuit that can be placed on the same printed circuit board (PCB) as the controller 22. Integrating the controller 22 and the frequency synthesizer 34 on the same PCB may provide additional cost savings and take less space in the laser-marking station 13.

The undeflected laser beam 30 is deflected as it passes through the AOD 39 depending on the frequency signal 41 emitted into the AOD 39. The amplitude of the frequency signal 41 dictates the intensity of the laser beam 18 or the efficiency at which the laser beam 30 is deflected by the AOD 39. The laser beam 18, as deflected by the AOD 39, places informative markings in a vertical direction on the product 10 in the form of dot markings 33. As the product 10 moves horizontally with respect to the laser-marking station 13, the laser beam 18 places two dimensional dot markings 33 on the product 10.

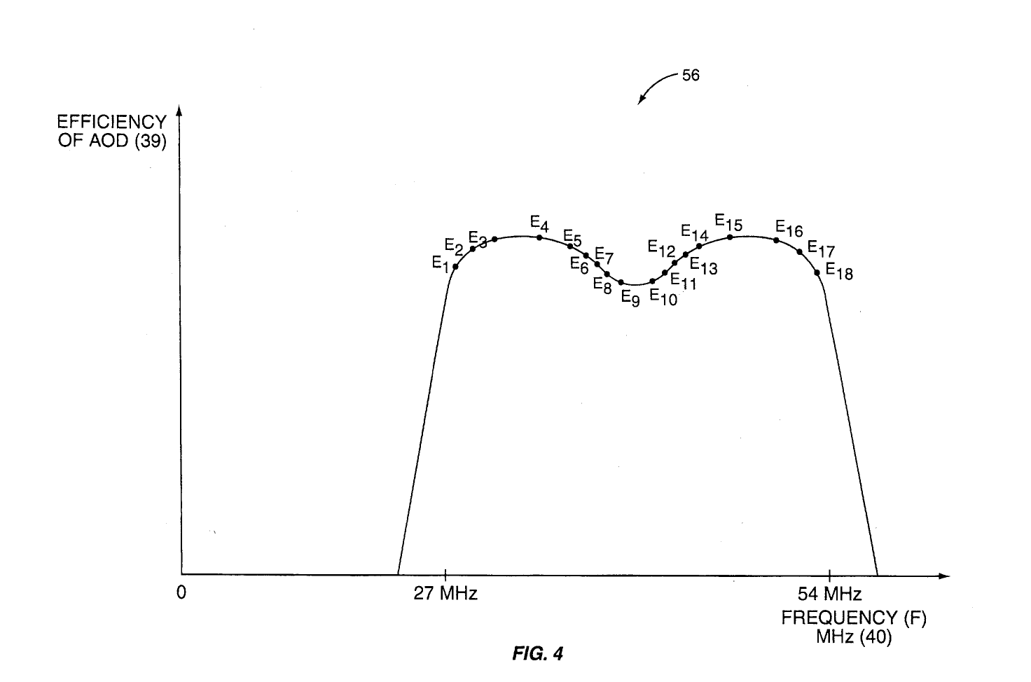

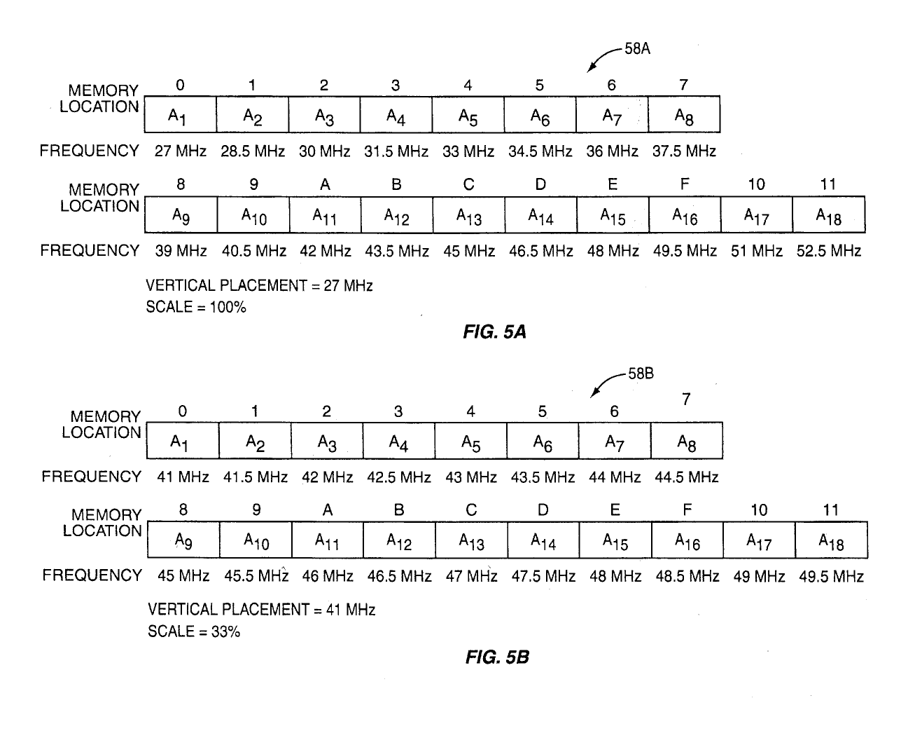

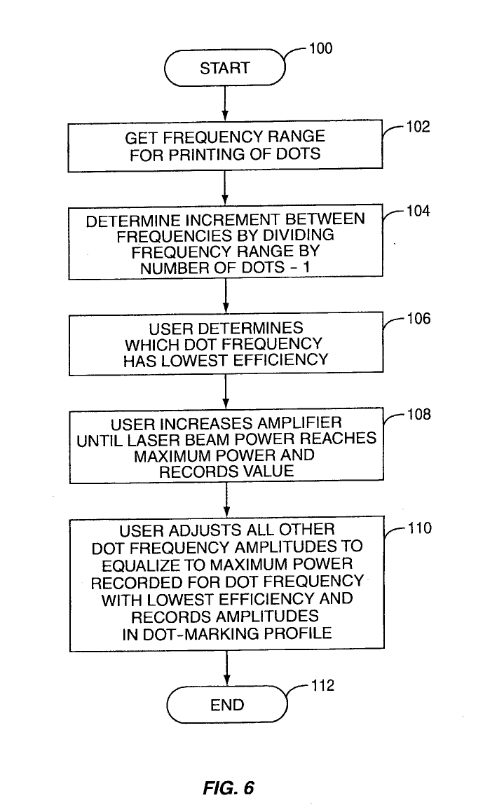

A power measurement device 31 is placed in the path of the laser beam 18 before it reaches the product 10 to measure the laser beam's 18 power. The power is directed to a laser beam power meter 26 so that a user 43 may create and configure dot-marking profiles to be stored in the controller 22 for printing dots 33 onto the product 10 in the desired area of the AOD efficiency curve 56 (illustrated in FIG. 4). Creation of dot-marking profiles is discussed later in this application and is illustrated in FIGS. 5A, 5B, and 6.

The controller 22 may also be configured to receive a product detection sensor signal 21 from a product detection sensor 20. The product detection sensor 20 detects when the product 10 is in front of the laser 16. The controller 22 controls the laser 16 to emit the undeflected laser beam 30 upon receipt of the product detection sensor signal 21. The product detection sensor 20 emits a product detection sensor signal 21 when the product 10 is detected. The product detection sensor 20 may be any type of sensor or device that can detect the physical presence of an object, such as a product 10, as it moves in front of the laser-marking station 13. Examples of product detection sensors 20 that may be used with the present invention are disclosed in co-pending Patent Application No. 09/823,666 entitled “Device and method for monitoring a laser-marking device,” filed on Mar. 31, 2001, incorporated herein by reference in its entirety.

In one embodiment, a user 43 manually configures the amplitudes of the dot frequencies used by the laser-marking device 13 to print dot markings 33 onto the products 10. The user 43 receives a laser beam power meter signal 24 from a laser beam power meter 26 to indicate the intensity of the laser beam 18 during configuration. The user 43 also receives the frequency signal power meter signal 24 from the frequency signal power meter 27 indicating the amplitude of the frequency signal 41. The user 43 uses the laser beam power meter 26 and the frequency signal power meter 27 to determine the efficiency curve of the AOD 39 over the frequency range of the AOD 39, discussed below and in FIG. 4, to store the amplitude of dot frequencies in a dot-marking profile, discussed below for FIGS. 5A, 5B and 6. The user 43 interacts with the user interface 40 to direct the controller 22 to store desired amplitudes for dot markings 33 to compensate for inefficiencies in the AOD 39 and to substantially equalize the dot intensities over the frequency range of the dot-marking profile.

The controller 22 is also configured to allow the user 43 interaction with the laser-marking station 13 through a user interface 40. The user interface 40 may be a computer system or other system having an input and optionally an output that allows the user 43 of the laser-marking station 13 to interact with the controller 22 through a user interface communication link 42. The controller 22 may also be coupled to various input devices, including but not limited to a keyboard (not shown), serial port (not shown), etc.

The input of the user interface 40 may include any device that can receive input, such as selections or commands. An input could comprise a mechanism requiring tactile contact by the consumer, for example a keyboard, keypad, touch screen display, or programmable function keys. Alternatively, the input of user interface 40 may be of a form that requires no physical contact, such as a transponder or other wireless communication, a smart card, speech recognition, or a direct link to a secondary device such as a personal digital assistant (PDA) or laptop computer.

The output of user interface 40 may comprise a text or graphic output display that may be of any technology or type known in the art, illustratively including any of a variety of liquid crystal displays (LCD), both Passive Matrix (PMLCD) and Active Matrix (AMLCD)—including Thin-Film Transistor (TFT-LCD), Diode Matrix, Metal-insulator Metal (MIM), Active-Addressed LCD, Plasma-Addressed Liquid Crystal (PALC), or Ferroelectric Liquid Crystal Display (FLCD). Alternatively, the display may comprise Plasma Display Panel (PDP), Electroluminescent Display (EL), Field Emission Display (FED), Vacuum Fluorescent Displays (VFD), Digital Micromirror Devices (DMD), Light Emitting Diodes (LED), Electrochromic Display, Light Emitting Polymers, video display (cathode ray tube or projection), holographic projection, etc. The display technologies discussed above are illustrative in nature, and are not intended to be limiting.

The output of user interface 40 may also be audible output. Additionally, the output may provide for the actual delivery of information in electronic form. This may be accomplished through communication to a secondary device, such as a computer in the consumer's automobile, a PDA or laptop computer, a mobile telephone terminal, or the like. Connection to the secondary device may be through a wired connection, as through a plug provided on user interface 40, or over a wireless radio or optical connection.

The user interface 40 may be used to configure and setup the laser-marking station 13 and/or the controller 22 for operation and functions discussed throughout this invention. Specifically, the user interface 40 may be used to program and/or configure the controller 22 before, during, or after operation of the laser-marking station 13 to create and/or modify dot-marking profiles, as discussed below.

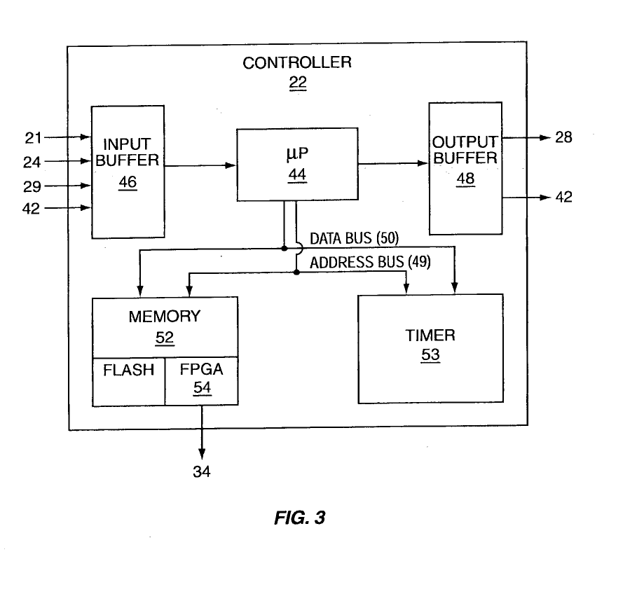

FIG. 3 illustrates one embodiment of the controller 22. In this embodiment, the controller 22 includes a microprocessor 44. The controller 22 also includes an input buffer 46 and an output buffer 48 for receiving input signals and sending output signals in response thereto. Inputs to the input buffer 46 include the product detection sensor signal 21 and the user interface communication link 42. The input buffer 46 may also be configured to include optional inputs including the laser beam timer 53 and any other memory-mapped peripheral device included. The memory 52 is used to store information required by the controller 22, including dot-marking profiles for controlling the dot markings 33 placed on the product 10. The memory 52 may include random-access memory (RAM), read-only memory (ROM), electronically programmable read-only memory (EPROM), electronically erasable programmable read-only memory (EEPROM) or flash memory. The memory 52 may also include a gate array, such as a field programmable gate array (FPGA) 54.

In this embodiment, the microprocessor 44 communicates with frequency synthesizer 34 through use of a field programmable gate array (FPGA) 54. As the user 43 configures the amplitudes of the dot frequencies for the AOD 39, the microprocessor 44 stores such amplitudes in the FPGA 54. As the laser 16 emits the laser beam 18 to create each dot in the dot markings 33, the FPGA 54 loads the desired frequency and amplitude into the frequency synthesizer 34 so that the frequency generator 19 emits the correct dot frequency signal 38 to the amplifier 36 to create the proper frequency signal 41 emitted into the AOD 39. Specifics on how dot-marking profiles are created are discussed later in this application.

A timer 53 may also be optionally provided if the controller 22 is required to perform calculations and/or control that requires knowledge of timing between events. The microprocessor 44 could also use a serial bus architecture that may operate in either a master/slave arrangement or peer-to-peer arrangement to communicate with peripherals or other devices coupled to the microprocessor 44, including the input buffer 46, the output buffer 48, the memory 52, and the timer 53.

An example of a serial bus architecture for embedded applications is called “LONWorks,” manufactured by Echelon Corporation, a description of which can be found at www.echelon.com/products and U.S. Pat. Nos. 4,918,690; 4,969,147; 5,034,882; 5,113,498; and 5,182,746, all of which are incorporated herein by reference in their entirety. Parallel and serial bus communications for the controller 22, whether they are master/slave or peer-to-peer communications, are well known in the art and by one of ordinary skill in the art. The present invention is not limited to any particular type of microprocessor 44 architecture or communication configurations.

In one embodiment of the present invention, the AOD 39 is a germanium crystal with an effective operating frequency between 27 MHz and 52.5 MHz. A frequency signal 41 between 27 MHz and 52.5 MHz is emitted to the AOD 39 causing the undeflected laser beam 30 to deflect in the vertical direction, thereby creating the dot markings 33. Frequencies outside this range have very poor efficiencies for this particular AOD 39. The efficiency of AOD 39 is defined as a ratio of intensity or power in undeflected laser beam 30 (I₀) over the ratio of intensity or power in undeflected laser beam 30 (I₀) plus the intensity or power in deflected laser beam 18 at a particular frequency signal 41 (I₁), or:

$$\frac{{I}_{0}}{{I}_{0} + {I}_{1}}$$

An illustration of the efficiency of a germanium crystal AOD efficiency curve 56 is illustrated in FIG. 4. The AOD 39 is capable of creating the dot markings 33 in eighteen different vertical positions. The eighteen discrete points, starting at 27 MHz and ending at 52.5 MHz, have frequency signal 41 increments at 1.5 MHz. In one embodiment, the laser-marking station 13 is configured to print the dot markings 33 on the product 10 in up to three lines, with six dots being available for each line. The germanium crystal AOD 39 is only capable of generating a maximum of eighteen dots over the frequency range of 27 MHz to 52.5 MHz without overlapping.

### CREATION OF DOT-MARKING PROFILES

1. User-Created Dot-Marking Profiles

The present invention allows dot-marking profiles to be created by the user 43 and stored in memory 52. The controller 22 uses the dot-marking profile to control the amplitude of the dot frequencies emitted into the AOD 39 to place the dot markings 33 on the products 10. The dot-marking profiles are representations of the dot frequency signal 38 amplitudes for a given set of frequencies emitted into the AOD 39 to substantially equalize the dot markings 33 intensity for all dots in the vertical direction. The dot-marking profiles are used to balance the dots over a more efficient range of the AOD 39. Dot-marking profiles also allow the laser-marking station 13 to quickly ascertain the correct amplitude for the dot frequency signal 38 without the controller 22 having to calculate the amplitudes for every dot frequency signal 38 emitted into the AOD 39. Such calculations are time consuming and resource intensive on the controller 22 and the microprocessor 44. Since the assembly line 12 is transporting the products 10 at a fast rate, the controller's 22 ability to emit the laser beam 18 properly and quickly is critical to ensure that the dot markings 33 are placed on the products 10 properly and at the correct speed.

FIGS. 5A and 5B illustrate two examples of dot-marking profiles 58 stored in the FPGA 54. FIG. 5A illustrates a dot-marking profile 58A having eighteen dot frequencies for eighteen dots in the vertical direction that are deflected by the AOD 39. Eighteen locations are used to store the amplitude for each of the dot markings 33, numbered 0-11 (hex). The frequency signals 38 in the dot-marking profile 58A start at 27 MHz for memory 52 location 0, and go to 52.5 MHz in location 11 (hex), with increments of 1.5 MHz between each dot marking 33. The frequencies stored in the locations indicate the middle frequency of the range for a particular dot. Dot frequency signal 38 increments of 1.5 MHz represent full scale of 100% since the maximum amount of dots that can be printed by a germanium crystal AOD 39 without overlapping of dots (i.e. contiguous dot frequencies less than 1.5 MHz), and the operative frequency range of germanium crystal AOD 39 is 27 MHz-52.5 MHz.

If dot frequency increments of less than 1.5 MHz are used, the dot markings 33 will overlap when printed on the product 10. Overlapping may be used as a technique to obtain higher resolution in the dot markings 33. The vertical position of the dot markings 33 is the frequency of the first dot marking 33 stored in the dot-marking profile 58A in location 0, or 27 MHZ, which is the lowest dot marking 33 in the vertical direction.

The amplitude of each dot marking 33 for a particular frequency is stored by the user 43 in the FPGA 54 in locations 0-11 (hex) to create the dot-marking profile 58. The user 43 optimizes amplitude values for each frequency signal 41 so that the dot intensities for all the dot markings 33 in the vertical direction are substantially the same. During creation of a dot-marking profile 58, the user 43 causes the controller 22 to emit the laser beam 18 at the different frequencies over the frequency range of the AOD 39. In a default dot-marking profile 58 setting, the entire frequency range of AOD 39, 27 MHz-52.5 MHz is used for the eighteen dots, and 1.5 MHz is the incremental frequency between each dot in the dot markings 33.

FIG. 5B illustrates an example of a dot-marking profile 58B having a N×18 profile that includes scaling. N is the number of dots in the horizontal direction, and 18 is the possible number of dots in the vertical direction that are deflected by the AOD 39. Eighteen locations are used to store the amplitude for each dot marking 33, numbered 0-11 (hex). The frequency signals 38 in the dot-marking profile 58B start at 41 MHz for location 0, and go to 49.5 MHz in location 11 (hex).

In this example, scaling is performed by the user 43 by decreasing the increments between dot frequencies to 0.5 MHz in the FPGA 54. The scaling used in this example is 33% of the full scale used in dot-marking profile 58A illustrated in FIG. 5A, or 0.5 MHz/1.5 MHz. The dot markings 33 will overlap using this dot-marking profile 58B, since the increment between dot frequencies is less than 1.5 MHz. The vertical position or placement is the frequency of the first dot marking 33 stored in the dot-marking profile 58B in location 0, or 41 MHz and used by the controller 22 to place dot markings 33 on the product 10. The lowest dot in the dot markings 33 will be at a deflection of 41 MHz in the vertical direction. Just as discussed for the dot-marking profile 58A in FIG. 5A, the user 43 causes the controller 22 to store the amplitude values for dot-marking profile 58B in locations 0-11 (hex) for each dot frequency to equalize dot intensity of dot markings 33 on the product 10 or power as measured by the laser beam power meter 26.

FIG. 6 is a flowchart illustrating the embodiment of how a dot-marking profile 58 is created by a user 43, as described above for FIGS. 5A and 5B. The process starts (block 100), and the frequency range of AOD 39 desired for printing of dots is input by the user 43 through the user interface 40 (block 102). The increment between dot frequencies is obtained by dividing the frequency range desired by the number of dots minus one to be printed onto the product 10 (block 104). As previously described, the controller 22 emits a laser beam 18 for each dot frequency, and the user 43 determines the dot frequency signal with the lowest efficiency (block 106).

The user 43 equalizes differences in dot frequency efficiencies of the AOD 39 over a desired frequency range when creating a dot-marking profile 58A. The user 43 causes the controller 22 to amplify the frequency signal 38 initially to a redefined setting, for example 40 Watts. The laser beam power meter 26 measures the laser beam 18 power to determine which frequency has the lowest efficiency in frequency range of the dot-marking profile 58. In the dot-marking profile 58A, the user 43 determines that the frequency of 40.5 MHz is the dot frequency with the lowest efficiency. The user 43 then causes the controller 22 to increase the amplitude in the amplifier 36 for the 40.5 MHz dot frequency until laser beam 18 power reaches a maximum value, typically between 80-85 Watts; however the amplifier 36 does not go beyond 50 Watts (block 108). Application of more than 50 Watts to a germanium crystal AOD 39 could cause damage to the AOD 39.

The user 43 monitors the frequency signal power meter signal 29 from the frequency signal power meter 27 to determine when the amplifier 36 reaches 50 Watts. The user 43 repeats this process for each dot frequency and causes the controller 22 to store amplitude values for each dot frequency, A₁ through A₁₆, between 40-50 Watts in memory 52 for dot-marking profile 58A, as illustrated in FIG. 5A (block 110), and the process ends (block 112). In this manner, all dot frequency amplitudes are configured to emit essentially the same dot intensity on product 10, or dot intensities as close to each other as possible.

2. Controller Created Dot-Marking Profiles

Another embodiment of the present invention for creating a dot-marking profile 58 involves the controller 22 using an existing dot-marking profile 58 stored in memory 52 as a base. This technique may be used to allow the controller 22 to create a dot-marking profile 58 in an automated fashion in lieu of a user 43 manually configuring and creating the dot-marking profile 58. The controller 22 is programmed with the desired frequency range and any specific configurations of the new dot-marking profile 58, including vertical placement and scaling, to create the new dot-marking profile 58. The controller 22 uses interpolation on the base dot-marking profile 58 to calculate and store amplitudes for dot frequencies that fall in between the dot frequencies in the base dot-marking profile 58.

For example, the controller 22 could use the dot-marking profile 58A illustrated in FIG. 5A to create the dot-marking profile 58B in FIG. 5B. The controller 22 is programmed with the beginning dot frequency of 41 MHz and increments between dot frequencies of 0.5 MHz. The controller 22 first determines if the dot frequency in the created dot-marking profile 58B exists exactly in the base dot-marking profile 58A. If it does, the controller 22 uses the same amplitude value in the base dot-marking profile 58A for the created dot-marking profile 58B for that particular dot frequency. The dot frequencies that appear exactly in both the base dot-marking profile 58A and the created dot-marking profile 58B are 42 MHz, 43.5 MHz, 45 MHz, 46.5 MHZ, 48 MHz, and 49 MHz.

In order for the controller 22 to calculate the amplitudes for dot frequencies in the created dot-marking profile 58B in between the common dot frequencies listed above, the controller 22 uses interpolation. The controller 22 calculates a dot frequency amplitude in the created dot-marking profile 58B by using the amplitudes in the base dot-marking profile 58A. For example, if the controller is calculating the amplitude of the dot frequency 42.5 MHz, the controller 22 will use the amplitudes in the base dot-marking profile 58A at 42 MHz and 43.5 MHz to interpolate the amplitude for 42.5 MHz. The interpolation calculation is as follows for the amplitude for 42.5 MHz.

$${A}_{42.5 MHz} = {A}_{42 MHz} + \frac{( ( {A}_{43.5 MHz} - {A}_{42 MHz} ) \times ( 42.5 MHz - 42 MHz ) )}{( 43.5 MHz - 42 MHz )}$$

In another embodiment, the controller 22 uses the AOD efficiency curve 56 illustrated in FIG. 4 to create a new dot-marking profile 58. The controller 22 does not need to use a base dot-marking profile 58A to create the new dot-marking profile 58 since the AOD efficiency curve 56 is used directly for interpolation. Just as in the preceding embodiment, the controller 22 is programmed with the beginning dot frequency, the increments between dot frequencies, and any other configuration information including scaling and vertical placement. The controller 22 uses interpolation to determine the in between dot frequencies for the newly created dot-marking profile 58 based on the AOD efficiency curve stored in memory 52, similar to the preceding embodiment.

Before the controller 22 can create a dot-marking profile 58 in this embodiment, the controller 22 must calculate and store the AOD efficiency curve 56 in memory 52. The controller 22 causes the frequency synthesizer 34 to emit the un-amplified frequencies into the AOD 39 as the undeflected laser beam 30 passes through the AOD 39 and onto the product 10. The laser beam power meter 26 measures the power of laser beam 18 as it is emitted from the AOD 39. The controller 22 stores these efficiency values for AOD 39 over the frequency range desired for a certain number of discrete points in memory 52. For example, if power measured by the laser beam power meter 26 is 140 Watts and power in the undeflected laser beam 30 is 100 Watts at a frequency signal 41 of 27 MHz, the efficiency of the AOD 39 at 27 MHz is 100 Watts /140 Watts, or 71.4%.

These efficiency values are shown as E₁, E₂, E₃. . . , E₁₈ in FIG. 4, and may be stored in memory 52 and used by the controller 22 to determine the dot frequency signal 38 emitted into the AOD 39. Some frequencies, such as the frequency around E₄, are more efficient than other frequencies, such as frequencies around E₁ and E₁₈.

### CHOOSING A DOT-MARKING PROFILE AND PLACEMENT OF DOTS

Once the laser-marking station 13 has one or more dot-marking profiles 58 stored in memory 52 and/or provided by user interface 40, the laser-marking station 13 may be configured to place the dot markings 33 on the product 10 in accordance with a chosen dot-marking profile 58.

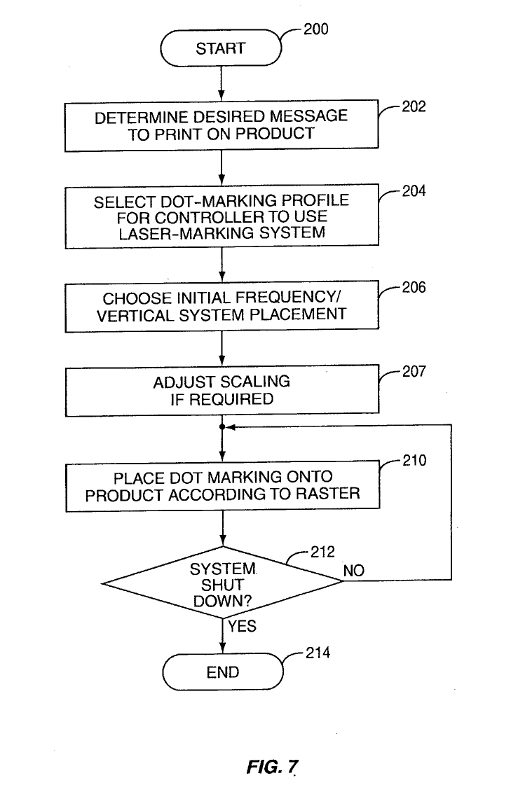

FIG. 7 illustrates a flow chart process for the user 43 and/or the controller 22 to choose the desired dot-marking profile 58 from memory 52 to print the dot markings 33 on the product 10. The process starts (block 200), and the controller 22 determines the message to be printed on the product 10 in the form of dot markings 33 (block 202). The message may be stored in memory 52 or input by the user 43 using the user interface 40. The user 43 and/or the controller 22 selects the desired dot-marking profile 58 to use in the FPGA 54 from the system configuration (block 204). The initial dot frequency for the dot markings 33 is chosen from the dot-marking profile 58. The first dot frequency is chosen in the dot-marking profile 58 for printing (block 206). The controller 22 may also be configured to allow vertical placement by preset indicators, such as top, middle or bottom, or specific line numbers if the controller 22 is configured to place the dot markings 33 on multiple lines.

The controller 22 may also adjust scaling of dot markings, if desired by the user 43 or required in the system configuration (block 207). Scaling is line size in terms of dots divided by number of dots to print as dot markings 33. For example, if the number of dots to print on the product 10 is eighteen and the dot-marking 33 line size is six dots, the scaling factor is 6/18 or 33%. If the number of dots to print is nine, and the dot-marking line size is eighteen dots, the scaling factor is 18/9 or 200%. Scaling is accomplished by taking the first dot frequency in dot-marking profile 58 and calculating all other dot frequencies based on a delta frequency. The delta frequency is the difference between contiguous dot frequencies in the dot-marking profile 58 times the scaling factor. If scaling is performed, the controller 22 must extrapolate amplitudes for all dot frequencies from the selected dot-marking profiles 58 to equalize inefficiencies between the dot frequencies, as previously discussed and illustrated in FIG. 6.

The controller 22 next places the dot markings 33 onto the product 10 according to text message in memory 52 or entered through the user interface 40 (block 210). The controller 22 places the dot markings 33 onto the product 10 according to a raster of text or characters comprising a text message. If a particular raster in a character does not call for a dot, the controller 22 does not emit a dot frequency signal 38 to the AOD 39. The undeflected laser beam 30 may still be emitted, but the AOD 39 is configured so that the undeflected laser beam 30 is deflected to a surface inside the laser head 17, and a cooling device, such as a heat sink, is used to dissipate heat built up in the laser head 17. If the laser-marking station 13 is not shut down and the products 10 continue to move on the assembly line 12 (decision 212), the controller 22 continues to place the dot markings 33 onto the product 10 (block 210). If the laser-marking station 13 has been shut down (decision 212), the process ends (block 214).

### EXAMPLES OF DOT MARKINGS

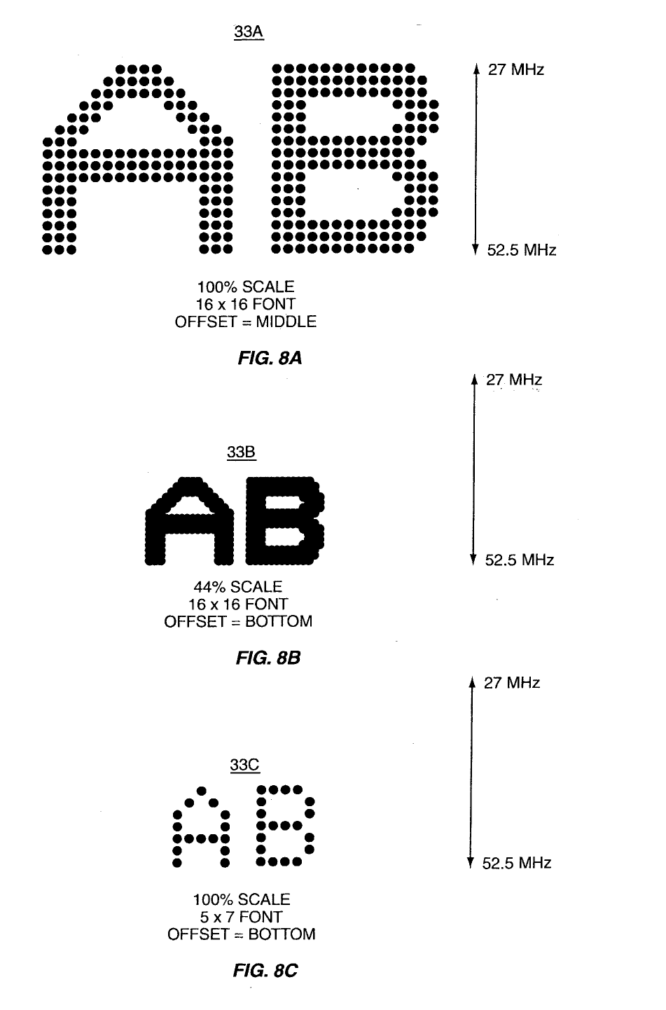

FIGS. 8A, 8B, and 8C illustrate examples of dot markings 33A, 33B, 33C created by the laser-marking station 13, using the dot-marking profiles 58A, 58B illustrated on FIGS. 5A and 5B. FIG. 8A illustrates a dot marking 33A of characters “AB” using an 16×16 font at full scale of 100% and middle vertical placement. The dot-marking profile 58A illustrated in FIG. 5A is used by the controller 22 in this example to configure and print the dot markings 33 in FIG. 8A.

FIG. 8B illustrates a dot marking 33B of “AB” just as in FIG. 8A, but with scaling at 44%. The controller 22 uses the dot-marking profile 58A illustrated in FIG. 5A, but dot frequency increments are in increments or delta frequencies of 0.66 MHz, which is 44.4% of 1.5 MHz, or line size in terms of dots divided by number of dots to print as dot markings 33 (8/18). Since the dot frequency increment is less that 1.5 MHz, dot markings 33 overlap one another. This technique can be used not only to scale down dot markings 33B, but also to obtain a higher resolution. Vertical placement is at the bottom at 52.5 MHz, just as illustrated in FIG. 8A. The controller 22 recalculates amplitudes for scaled delta frequencies just as previously described in FIG. 6 to equalize laser beam 18 power or dot intensities.

FIG. 8C illustrates a dot marking 33C of “AB” in an 5×7 font at full scale of 100% with vertical placement starting at the bottom at 52.5 MHz. The dot-marking profile 58A illustrated in FIG. 5A was used by the controller 22 to create the dot marking 33C. Note that the dot-marking profile 58B illustrated in FIG. 5B could have also been used by the controller 22. Scaling would be 33% of the size in illustrated in FIG. 8C, and vertical placement relative to 49.5 MHz, instead of 52.5 MHz. The dot-markings 33 in FIG. 8C use the dot-marking profile 58B that is optimized for image specifications. The dot markings 33 do not overlap since the dot frequencies between contiguous dots are not less than 1.5 MHz.

Certain modifications and improvements will occur to those skilled in the art upon a reading of the foregoing description. It should be understood that the present invention is not limited to any particular type of product 10, assembly line 12, laser-marking station 13, laser 16, laser beam 18, product detection sensor 20, controller 22, or particular electronic circuitry comprising controller 22, laser beam power meter 26, frequency synthesizer 34, amplifier 36, acousto-optic deflector 39, or user interface 40. Any type of AOD 39 may be used with the present invention. Image, marking, and dot marking 33 are used interchangeably and have the same meaning in the context of the present invention. The present invention is not limited to an AOD 39 that can only deflect eighteen dot markings 33 in the vertical direction or has a specific frequency range of 27 MHz to 52.5 MHz. In addition, coupled includes connected, whether directly connected or connected through some other form, such as wireless communication, infrared, and optical signaling, or reactively coupled, whether by capacitance or inductance.

One of ordinary skill in the art will recognize that there are different manners in which the elements discussed above can be configured to operate to accomplish the present invention. The present invention is intended to cover what is claimed and any equivalents. The specific embodiments used herein are to aid in the understanding of the present invention, and should not be used to limit the scope of the invention in a manner narrower than the claims and their equivalents.

What is claimed is:

1. A laser-marking system to place dot markings onto a product, comprising:
a laser that emits a laser beam through an acousto-optic deflector to place the dot markings onto the product;
a controller coupled to a memory and coupled to said laser to control when said laser emits said laser beam; and
a frequency synthesizer coupled to said controller that emits an amplified dot frequency signal into said acousto-optic deflector to change the index of refraction of said acousto-optic deflector and deflect the dot markings;
said controller controls said frequency synthesizer to control the height of the dot markings by controlling the increment frequency in said dot frequency signals between said dot markings.

2. The system of claim 1, wherein said dot markings overlap each other on the product.

3. The system of claim 2, wherein said increment frequency is less than 1.5 MHz.

4. The system of claim 1, wherein said increment frequency is calculated by multiplying a scaling factor times one of said dot frequency signals.

5. The system of claim 1, wherein the height of the dot markings is configured by a user interface coupled to said controller.

6. The system of claim 1, further including at least one dot-marking profile in said memory.

7. The system of claim 6, wherein said memory is comprised of a FPGA.

8. The system of claim 7, wherein said at least one dot-marking profile contains an amplitude for each of said dot frequency signals that is used by said controller to control said frequency synthesizer to adjust for the difference in efficiencies of said acousto-optic deflector for each of said dot frequency signals to substantially equalize said dot marking intensities.

9. The system of claim 8, wherein said at least one dot-marking profile contains said increment frequency in said dot frequency signal.

10. The system of claim 8, wherein a second dot-marking profile contains amplitudes extrapolated from said amplitudes from said at least one dot-marking profile.

11. The system of claim 1, further including a plurality of dot-marking profiles in said memory.

12. The system of claim 7, wherein said at least one dot-marking profile is modifiable by a user interface coupled to said controller.

13. The system of claim 1, wherein the maximum amount of said dot markings is 18.

14. The system of claim 1, further comprising a laser beam power meter to measure the power of said laser beam to determine an inefficiency of said acoustic-optic deflector for said dot frequency signal.

15. The system of claim 15, further comprising a frequency signal power meter to measure the amplitude of said dot frequency signal so that the amplitude of said dot frequency signal can be adjusted according to the power of said laser beam measure by said laser beam power meter.

16. A laser-marking system to place dot markings onto a product, comprising:
a laser that emits a laser beam through an acousto-optic deflector to place the dot markings onto the product;
a controller coupled to a memory and coupled to said laser to control when said laser emits said laser beam; and
a frequency synthesizer coupled to said controller that emits a dot frequency signal into an amplifier and onto said acousto-optic deflector to change the index of refraction of said acousto-optic deflector and deflect the dot markings;
said controller controlling said frequency synthesizer and adding an offset to said dot frequency signals to control the vertical placement of the dot markings on the product.

17. The system of claim 15, further including at least one dot-marking profile in said memory.

18. The system of claim 17, wherein said at least one dot-marking profile contains an amplitude for each of said dot frequency signals that is used by said controller to control said amplifier to adjust for efficiency of said acousto-optic deflector and equalize said dot marking intensities.

19. The system of claim 17, wherein a first of said dot frequency signals to control the vertical placement is contained in a dot-marking profile in said memory.

20. The system of claim 19, wherein all of said dot frequency signals to control the vertical placement are contained in said dot-marking profile in said memory.

21. The system of claim 16, further including a plurality of dot-marking profiles in said memory.

22. The system of claim 17, wherein said at least one dot-marking profile is modifiable by a user interface coupled to said controller.

23. A laser-marking system to place dot markings onto a product, comprising:
a laser that emits a laser beam through an acousto-optic deflector to place the dot markings onto the product;
a controller coupled to a memory and coupled to said laser to control when said laser emits said laser beam;
a frequency synthesizer coupled to said controller that emits a dot frequency signal into an amplifier and onto said acousto-optic deflector to change the index of refraction of said acousto-optic deflector and deflect the dot markings; and
said controller accessing a dot-marking profile in memory and controlling said frequency synthesizer to emit said dot frequency signal according to said dot-marking profile.

24. The system of claim 23, wherein said dot-marking profile contains an amplitude for each of said dot frequency signals that is used by said controller to control said amplifier to adjust for the difference in efficiencies of said acousto-optic deflector for each of said dot frequency signals to substantially equalize said dot marking intensities.

25. The system of claim 24, wherein a second dot-marking profile contains amplitudes extrapolated from said amplitudes from said dot-marking profile.

26. The system of claim 23, wherein said dot-marking profile contains an increment frequency in said dot frequency signal to place said dot markings onto the product at different locations in the vertical plane.

27. The system of claim 23, further including at least one additional dot-marking profile in said memory.

28. The system of claim 23, wherein said dot-marking profile is modifiable through a user interface coupled to said controller.

29. A method of determining the efficiency of an acousto-optic deflector in a laser-marking system over a given frequency range, comprising the steps of:
a) emitting dot frequency signals onto the acousto-optic deflector over the frequency range of the acousto-optic deflector while emitting said laser beam to place dot markings on a substrate; and
b) measuring the intensity of each of said dot markings on said substrate for each of said dot frequency signals emitted.

30. The method of claim 29, further comprising the step of storing the intensity of said dot markings for each of said dot frequency signals.

31. The method of claim 29, further comprising performing steps (a)-(b) during initialization of the laser-marking system.

32. The method of claim 29, further comprising performing steps (a)-(b) by interacting with a user interface in the laser-marking system.

33. A method of scaling the height of dot markings placed onto a product by a laser emitting a laser beam through an acousto-optic deflector onto the product, comprising the steps of:
a) determining a first dot frequency signal to emit onto the acousto-optic deflector to control the placement of a first dot marking onto the product; and
b) calculating all other dot frequency signals to emit onto the acousto-optic deflector to place other dot markings onto the product based on a delta frequency from said first dot frequency signal to control the height of said dot markings.

34. The method of claim 33, further comprising creating a dot-marking profile containing an amplitude for said first dot frequency signal and said other dot frequency signals to compensate for the difference in efficiencies of the acousto-optic deflector between said first dot frequency signal and said other dot frequency signals.

35. The method of claim 34, further comprising the steps of:
measuring the power of said laser beam when at least one said dot frequency signal is emitted to said acousto-optic deflector; and
adjusting said amplitude of said at least one dot frequency signal until maximum power is reached for the dot frequency with the highest efficiency in said dot-marking profile;

36. The system of claim 35, further comprising the steps of:
measuring all of said dot frequency signals emitted to said acousto-optic deflector; and
and adjusting said amplitude of said all of said dot frequency signals until maximum power is reached for the dot frequency with the highest efficiency in said dot-marking profile.

37. The method of claim 34, further comprising applying said first dot frequency signal and said other dot frequency signal at an amplitude from said dot-marking profile on the acousto-optic deflector.

38. The method of claim 34, wherein said dot-marking profile further includes said first dot frequency signal and said other dot frequency signals for each said amplitude to place said dot markings onto the product at different locations in the vertical plane.

39. The method of claim 33, wherein said delta frequency is small enough to cause overlapping of said dot markings on the product.

40. A method of adjusting the vertical placement of dot markings placed onto a product by a laser emitting a laser beam through an acousto-optic deflector onto the product, comprising the steps of:
a) determining dot frequency signals to emit onto the acousto-optic deflector to control the placement of dot markings onto the product; and
b) adding an offset to each of said dot frequency signals to control the vertical placement of said dot markings on the product.

41. The method of claim 40, further comprising creating a dot-marking profile containing an amplitude for said dot frequency signals and to compensate for the difference in efficiencies of the acousto-optic deflector between said dot frequency signals.

42. The method of claim 41, further comprising the steps of:
measuring the power of said laser beam when at least one said dot frequency signal is emitted to said acousto-optic deflector; and
adjusting said amplitude of said at least one dot frequency signal until maximum power is reached for the dot frequency signal with the highest efficiency in said dot-marking profile;

43. The system of claim 42, further comprising the steps of:
measuring all of said dot frequency signals emitted to said acousto-optic deflector; and
and adjusting said amplitude of said all of said dot frequency signals until maximum power is reached for the dot frequency signal with the highest efficiency in said dot-marking profile.

44. The method of claim 40, further comprising applying said dot frequency signals at an amplitude from said dot-marking profile on the acousto-optic deflector.

45. The method of claim 44, wherein said dot-marking profile further includes said first dot frequency signal and said other dot frequency signals for each said amplitude to place said dot markings onto the product at different locations in the vertical plane.

46. A method of creating a dot-marking profile for use by a laser-marking system that emits a laser beam from a laser through an acousto-optic deflector onto a product, comprising the steps of:
a) determining the frequency range of dot frequencies to print onto the product;
b) determining an increment frequency between said dot frequencies to be emitted onto the acousto-optic deflector between subsequent said dot markings placed onto the product for the desired height of said dot markings;
c) determining the dot frequency signal with the lowest efficiency;
d) increasing the amplitude of said dot frequency signal with the lowest efficiency until its power reaches a maximum value; and
e) adjusting the amplitudes of the remaining of said dot frequencies.

47. The method of claim 46, further comprising storing said dot frequencies for each of said amplitudes in memory.

48. The method of claim 46, further comprising determining a vertical placement of said dot markings by determining a vertical base dot frequency signal.

49. A method of placing dot markings onto a product by emitting a laser beam from a laser through an acousto-optic deflector onto the product, comprising the steps of:
a) selecting a dot-marking profile containing dot frequency signal amplitudes correlating to the efficiency of the acousto-optic deflector for a particular dot frequency signal range;
b) emitting a dot frequency signal onto the acousto-optic deflector at said dot frequency signal amplitude according to said dot-marking profile for said dot frequency signal; and
c) emitting a laser beam through the acousto-optic deflector onto the product.

50. The method of claim 49, further comprising creating a dot-marking profile containing an amplitude for said dot frequencies and to compensate for the difference in efficiencies of the acousto-optic deflector between said dot frequencies.

51. The method of claim 49, further comprising the steps of:
measuring the power of said laser beam when at least one said dot frequency signal is emitted to said acousto-optic deflector; and
adjusting said amplitude of said at least one dot frequency signal until maximum power is reached for the dot frequency signal with the highest efficiency in said dot-marking profile;

52. The method of claim 49, further comprising calculating a delta frequency for said dot frequency signal to control the vertical height of the dot markings.

53. The method of claim 52, further comprising selecting a delta frequency that is small enough to cause overlapping between the dot markings on the product.

54. The method of claim 49, further comprising adding an offset to said dot frequency signal to adjust the vertical placement of the dot markings.
